(19) United States
(12) Patent Application Publication
(10) Pub. No.: US 2009/0304948 A1
(43) Pub. Date: Dec. 10, 2009

(54) ENVIRONMENTALLY FRIENDLY, SOLVENT-FREE PRINTING INK AND USE THEREOF

(76) Inventors: Markus Witter, Burg (DE); Marion Homuth, Jena (DE); Christian Tiller, Jena (DE); Heiko Schneider, Schwerte Ergste (DE); Joachim Schuler, Bad Saulgau (DE); Wolfgang Weiss, Bad Saulgau (DE)

Correspondence Address: JORDAN AND HAMBURG LLP, 122 EAST 42ND STREET, SUITE 4000, NEW YORK, NY, 10168, US

(21) Appl. No.: 12/309,901

(22) PCT Filed: Jul. 26, 2007
(86) PCT No.: PCT/DE2007/001350

§ 371 Date: Mar. 25, 2009

(30) Foreign Application Priority Data
Aug. 1, 2006 (DE) 10 2006 036 995.5

(51) Int. Cl. B05D 3/06; C09D 11/02

(52) U.S. Cl. 427/511; 523/160

(57) ABSTRACT

The invention relates to an environmentally friendly, solvent-free printing ink, particular for printing single-pane safety glass, and also to its use in the form of a process for producing this printing, for example as an alternative way of achieving an in-line coloration of flat glass.

The problem addressed by this invention, that of providing an environmentally-friendly, solvent-free printing ink, in particular for colored printing of a substrate, for example glass/single-pane safety glass, and also the use of this printing ink which avoids the disadvantages of the prior art is solved by the presence of a pigmented system in a lacquer slurry, the printing ink being water soluble and digitally printable, so that a process for producing a coating on glass using this printing ink comprising the steps of
cleaning the glass surface (in glass washing system or manually by using special cleaner [comprising acetic acid])
pretreating the glass surface in a flame pyrolysis process to generate an SiOₓ layer (addition of siloxanes into the flame)
applying an adhesion-promoting primer (primer) by air brush (adhesion promoter based on isopropanol and comprising silane as adhesion-promoting component)
flushing the primer layer off (for about 5 min in the example)
preparing the printed image with the invention's CPS by means of a commercial digital ink jet process
curing the CPS by means of infrared,
   is made possible.

### BACKGROUND OF THE INVENTION

The invention relates to an environmentally friendly, solvent-free printing ink, particular for printing single-pane safety glass, and also to its use in the form of a process for producing this printing, for example as an alternative way of achieving an in-line coloration of flat glass.

Due to its wide variety of applications glass is a popular and frequently used material. So, glass is also used, among others, as safety glass in form of single-pane safety glass and multilayer glass.

Single-pane safety glass is used everywhere where the safety requirements concerning bending strength and thermal-shock resistance are of high importance. These conditions are, for example, significant for glass doors, banisters, and elevator claddings and particularly for facades. Single-pane safety glass is produced from a normal float glass by means of a special pre-tensioning process. In this process, the already formed glass is heated over the transformation temperature and than rapidly cooled down by using an “air shower” that has a defined pressure.

Safety glass is printed for decoration purposes or optical enhancement as well as for providing necessary information. And for decades screen printing has been the first choice to include a decorative, informative or functional element on glass. This technology offers the possibility to print arbitrary, geometrically not definable forms or images on glass.

The matrix screen printing process allows finely graduated shades and thus produces manifold optical effects.

Apart from the advantages mentioned above, screen printing suffers from serious disadvantages, too. Besides the high burning-in temperatures of the inks, further problems are the set-up times when replacing one ink with another one or when changing the decorative design. It is not only necessary to remove all residual ink from the screens and doctors with extreme care, but the dosing tanks and feed vessels must be cleaned accurately, too. These cleaning procedures are very time-consuming and mostly they cannot be carried out without using solvents. Thus, the increasing problem for the industrial users is not just the ecological damage; also the long set-up times are ineffective and therefore cost-intensive.

Moreover, the screens must be changed and cleaned, if different images are to be printed. In addition to this, a new screen must be produced for each new design and thus considerable expenses are involved. An easy change of inks and printing images is not possible then.

At present, two different systems are available for the coloration of glasses:
1. ceramic inks
2. organic inks (UV-curing)

The ceramic inks are dried after screen printing and then burnt-in at 600° C. At these temperatures, the porcelain enamel combines with the glass and the result is a compound that exhibits a high adhesive strength, weathering stability and scratch resistance. But due to the heavy metals contained in these porcelain enamels, the color palette has been reduced continuously in the last years.

The total costs for the screen printing process with ceramic inks come to about 71.00 ε/h, all costs for modules and energy included. The costs for screen printing with UV curing inks, however, amount to only about 12.00 ε/h. The process times are also different. Whereas the process using ceramic inks requires ca. 2 hours per object, the application of UV curing inks can be diminished to 1 minute per object.

A further advantage of organic inks compared to ceramic systems is their higher variety and easy curing by UV radiation. They need only a short thermal post-curing phase to achieve a higher scratch resistance. However, these inks do not offer high a hardness and abrasion resistance as inorganic systems. Moreover, they need a glass pretreatment (Pyrosil®) to obtain adhesive compounds. The most serious disadvantage of acrylic-based organic inks is their low weathering resistance that makes an outdoor use impossible. A further problem of the organic systems is caused by the solvents that are specified in the VOC regulation but frequently used for applying the inks and for cleaning the equipment.

In the manufacture of color printed/rolled single-pane safety glass panes for different applications, the decorative or even informative elements are provided on the float glass by using the porcelain enamel inks in the screen printing process described above with said glass being still untreated, but already cut to size, drilled, grinded and possibly bent.

Afterwards, the printed glass is pre-tensioned to the single-pane safety glass. As high temperatures are required both for the pre-tensioning procedure and the burning-in process of the inks, the glass refiners have already started to combine the two energy-intensive procedures.

But this step leads again to new difficulties with respect to the printed porcelain enamel coatings. Due to the tensions in the glass, which are caused by the pre-tensioning process, the patterns and images are often distorted, flake off from the edges or are imperfect because of the slight deformations of the glass surface. The glass worker can almost not influence these production conditions and thus multiple single-pane safety glasses of lower quality are produced and are the reason for customers' claims about the irregular representation of the images. And the glass panes that end up in the scrap due to flaked off porcelain enamel edges are to be considered, too. The risk of broken glass is much higher for printed/rolled glasses than for glasses that are not printed. The costs and the time required for the necessary post-production of broken glass and all subsequently mentioned efforts and expenses involved cannot be calculated.

The object of the glass fabricator is to print the single-pane safety glass only after it has been treated and pre-tensioned. This demand requires the use of an aqueous-based ink system that dries at considerably lower temperatures and during a minimum period of time. Moreover, the ink shall be deposited by means of an alternative application system that is suited for such kinds of inks and is capable to reproduce the decorative design and writings without edge bleeding. But the methods and coating systems available on the market at present do not fulfill this requirement. An alternative of the methods and systems mentioned before has not been provided so far.

Besides the high burning-in temperatures of the porcelain enamel inks, the decisive disadvantages of screen printing are the set-up times when replacing one ink with another or when changing the decorative design. It is not only necessary to remove all residual ink from the screens and doctors with extreme care, but the dosing tanks and feed vessels must be cleaned, too. These cleaning processes are very time-consuming and mostly they cannot be managed without using solvents. Thus, the increasing problem for the industrial users is not just the ecological damage; also the long set-up times are ineffective and therefore cost-intensive. Moreover, the screen must be changed and cleaned, if different images are to be printed. In addition to this, a new screen must be produced for each new design and thus considerable expenses are necessary. That means that an easy change of inks and printing images is not possible.

In the manufacture of color printed or rolled single-pane safety glass panes for different applications, the decorative or even informative elements are provided on the float glass by using the porcelain enamel inks in the screen printing process described above with said glass being still untreated, but already cut to size, drilled, grinded and possibly bent. Afterwards, the printed glass is pre-tensioned to the single-pane safety glass. As high temperatures are required both for the pre-tensioning procedure and the burning-in process of the inks, the glass refiners have already started to combine the two energy-intensive procedures. But this step leads again to new difficulties with respect to the printed porcelain enamel coatings. Due to the tensions in the glass that are caused by the pre-tensioning process the patterns and images are often distorted, flake off from the edges or are imperfect because of the slight deformations of the glass surface. And the glass panes that end up in the scrap due to flaked off porcelain enamel edges are to be added. The risk of broken glass is much higher for printed/rolled glasses than for glasses that are not printed.

Actually, coating powders have been used as emission-free coating materials in very different industrial fields for decades but they can only be deposited on larger areas due to their treatment properties, i.e. decorations, patterns or writings cannot be applied, e.g. by printing.

The application of decorative designs, patterns or writings to glass/single pane safety glass requires printing techniques (in the prior art this is normally done by screen printing with ceramic inks) and consequently liquid systems.

Beside ceramic inks it is also possible to use other liquid systems based on solvents.

However, very smooth surfaces, glass in particular involve the risk that the coatings do not bond sufficiently according to the state of the art.

The publication DE 198 46 650 A1 describes a slurry with microencapsulated particles. According to this disclosure, a clear coating powder slurry includes at least one binder A containing a hydroxyl group, at least one polyisocyanate as a cross-linking agent B and water. Said hydroxyl group containing binder A and said polyisocyanate B are homogenized in such a way that no less than 30, preferably no less than 60 and especially no less than 90 wt. % of the polyisocyanate B is dispersed or dissolved in the particles containing the binder A, and the particles of the cross-linking agent B that are possibly still in the aqueous phase and the particles containing the binder A and the cross-linking agent B are stabilized via the isocyanate groups, still present on their surface, by using a deactivation agent added to the aqueous phase.

This clear coating powder is, for example, used as a clear lacquer in car painting. In large-lot production, a complete car body is provided with clear coating powder that is applied in its aqueous phase.

But these slurries have the disadvantages that that they are not colored and do not permanently bond to the glass surfaces after their application.

### SUMMARY OF THE INVENTION

Therefore, it is the object of the present invention to provide an environmentally-friendly, solvent-free printing ink, in particular for color-printing a substrate, e.g. glass/single-pane safety glass, and to specify a use thereof that avoids the disadvantages of the prior art.

The invention is grounded on the provision of a novel printable ink system based on coating powder slurries (hereinafter referred to as CPS) in form of a digitally printable, solvent-free inks and of a method for applying said coating powder slurries (CPS) on a substrate (the method including a pre-treatment technique, digital printing technology such as ink-jet printing and a curing technique for an inline, i.e., continuous, process). The term “solvent-free” as used in the present specification and claims means free of organic solvent, namely, the medium used in the present invention is, instead, water.

This invention provides novel printing inks based on coating powder slurries (CPS) and a digital printing technology adjusted to it.

Like in screen printing on glass, this method ensures the possibilities of manifold designs in order to produce different images, geometric forms, decorative elements or writings on the glass surface.

The inventive printing inks based on CPS
a) can be produced and used in all shades of color to freely design the glass surface,
b) can be processed in digital printing technology (this also includes the parallel printing of CPS of different colors without the problem that the individual shades of color bleed),
c) bond very well to the glass surface to be printed,
d) are characterized by a high mechanical strength and optical stability (thus, they can also be used in outdoor applications), and
e) exhibit a high weathering resistance.

An inventive use of the CPS-based printing inks is the application of an appropriate, efficient technology for coating processes, in which coating powder slurries are applied, and for curing said slurries.

The inventive color coating powder slurries require considerably lower temperatures for curing than porcelain enamel inks. Thus, the use of infrared heat radiators not only leads to the desired effect of complete drying and polymerization of the ink layers, but compared with commonly applied coating powders the drying time, which takes about 10 min in conventional heating furnaces and is therefore not compatible for an inline process, is also reduced.

Furthermore, the unfavorable interactions of the thermal burning-in process of ceramic inks and the “pre-tensioning” procedure of the glass panes caused by thermal effects are avoided. Such negative effects are often the reason for lack in quality and a higher reject rate.

To achieve a sufficient bonding of the ink layers to the glass surfaces, the coating powder slurries are prepared with an appropriate adhesion agent and the glass surface is provided with a surface activation agent adjusted to the ink system to obtain adherent-stable and weather-resistant coatings or printings.

Thanks to the provision of the inventive ink system on the basis of coating powder slurries that
a) in clude environmentally-friendly components (i.e. they do not contain heavy metals and solvents),
b) allow a simple coating method and an energy-efficient curing technology,
c) can be applied on the glass surface so that they reliably bond to it thanks to an appropriate system for pretreating the surface,
   and thanks to the combination of the single process steps to one inline procedure, the users in the glass industry have a product palette and technology at their disposal to substitute for the ceramic screen printing inks which have been used so far and partly contain heavy metals. So, they can work without the cost-intensive and time-consuming screen printing and burning-in technologies.

According to this invention, the porcelain enamel inks are substituted by the inventive ink having the corresponding weathering resistance (also for outdoor applications) so that by the inventive printing a new coating technology for glass surfaces/a new coating on glass surfaces is provided simultaneously.

The inventive method is a simple and cost-effective printing glass process that ensures the color variety according to the RAL spectrum and is stable against chemical influences of the environment.

The inventive coating powder slurry technology combines the advantages of water (slurry) and coating powder. The inventive pigmented system is an extremely fine coating powder suspension based on polyester-epoxide in water and additives.

The additives stabilize the coating powder/water mixture and optimize the process of the resulting coating. After suspension, the mixture is wet-ground to effect a particle size of 3 μm. The product can be processed in paint-spray lines and applied like a conventional water lacquer.

A very interesting economic advantage of this method is the fact that cohesive coating powder films can be achieved even for a dry coat thickness from 15 μm. After flushing the water off, CPS are burnt at object temperatures of 160° C. for at least 10 min. As a result, high-quality coating powders are provided that show a very good flow, high corrosion resistance and favorable mechanical properties. Moreover, CPS fulfill the VOC regulation because they do not contain solvents.

The inventive colored CPS allow the processing with up-to-date printing systems. In particular, the present invention makes it possible to print CPS by using ink jet technology. Thus, the invention offers the advantage that the decorative designs and writings can be applied with a high resolution and a minimum consumption of ink.

Up to now, CPS have only been processed as clear lacquer systems. The inventive production of printable CPS in a broad range of colors opens important new fields of application for the inventive printable chromatic CPS due to the overlay of three chromatic colors (cyan, magenta, yellow) or the individually formulated single colors.

According to this invention, the printable/sprayable, solvent-free chromatic CPS are provided with pigment articles (preferably 3 μm) that do not exceed a specified size to keep the flowability of the system for the application in print heads, most of all the penetration through the nozzle openings.

On the other side, a sufficient coating capability of the inventive inks is achieved and the stability of the dispersion is ensured to avoid a sedimentation of the inventive solid-liquid mixture, e.g. in the reservoir tank or the print head.

According to the present invention, the sufficient bonding of the novel ink system to the glass surfaces is attained by using adhesion promoters.

Like the porcelain enamel inks, the inventive CPS are characterized by a high mechanical strength and chemical stability. This is ensured by the substances that are contained in the inventive ink system and guarantee a sufficient surface hardness achieved, among others, by overcoating the printed areas with a scratch-resistant clear lacquer, e.g. based on a transparent CPS.

The advantage of the inventive CPS is ensured by the fact that the system also shows the very good properties of the porcelain enamel inks, but simultaneously it is not limited in its color range and less complicated and cost-intensive than the known porcelain enamel procedures.

The inventive printing (coating) and the inventive technology allow to color the surface of single-pane safety glass and even of float glass, because the high burning-in temperatures are not required.

Apart from the novel coating, a new technology is provided for processing these lacquers that makes the printing and immediate thermal curing of large-size glass substrates in the inline process possible and consumes less time, energy and money than conventional screen printing.

Coating powder slurries require considerably lower temperatures for curing than porcelain enamel inks. Thus, the use of infrared heat radiators cannot only lead to the desired effect of complete drying and polymerization of the ink layers, but compared with commonly applied coating powders the drying time, which takes about 10 min in conventional heating furnaces and is therefore not compatible for an inline process, is also reduced. To achieve a sufficient bonding of the ink coatings on the glass surfaces the coating powder slurries are prepared with an appropriate adhesion promoter and the glass surface is provided with a surface activation agent adjusted to the ink system to be able to apply adherent-stable and weather-resistant coatings.

Thanks to the provision of the inventive ink system based on coating powder slurries that
1. contain environmentally-friendly components (i.e. they are free from heavy metals and solvents),
2. allow a simple coating method and an energy-efficient curing technology, and
3. can be deposited on the glass surface so that they reliably bond to it thanks to an appropriate system for pretreating the surface
   the users in glass industry have a product palette and technology at their disposal that substitutes the ceramic screen printing inks which have been used so far and partly contain heavy metals. So, they can work without the cost-intensive and time-consuming screen printing and burning-in technologies.

The inventive coating and the inventive technology, which keeps the very good properties of the porcelain enamel screen printing inks but allows to save time, energy and costs, are considerably less complicated and cost-intensive than the prior art without limitation in the color range.

This inventive system allows to apply colors to the surfaces of single-pane safety glass (and even float glass) because the high burning-in temperatures are not required.

In the following, one embodiment and FIG. 1 explain the invention in detail.

### BRIEF DESCRIPTION OF THE DRAWINGS

FIG. 1 is a schematic cross-section of a glass substrate coated or printed upon according to the invention.

### DETAILED DESCRIPTION OF THE INVENTION

### Embodiment

The inventive, environmentally-friendly, solvent-free chromatic CPS are preferably used for printing glass panes (e.g. single-pane safety glass). The method for producing these printed glass panes comprises the following steps:
1. cleaning the glass surface (in glass washing systems or manually by using a special cleaner [comprising acetic acid]),
2. pretreating the glass surface in a flame pyrolysis process to produce an SiOₓ layer (addition of siloxanes into the flame),
3. applying an adhesion-promoting primer by air brush (adhesion promoter based on isopropanol and containing silane as an adhesion-promoting component),
4. flushing the primer layer off to remove excess primer (for about 5 min in the example),
5. preparing the printed image with the inventive CPS by means of a commercial digital ink jet process,
6. curing the CPS by means of infrared.

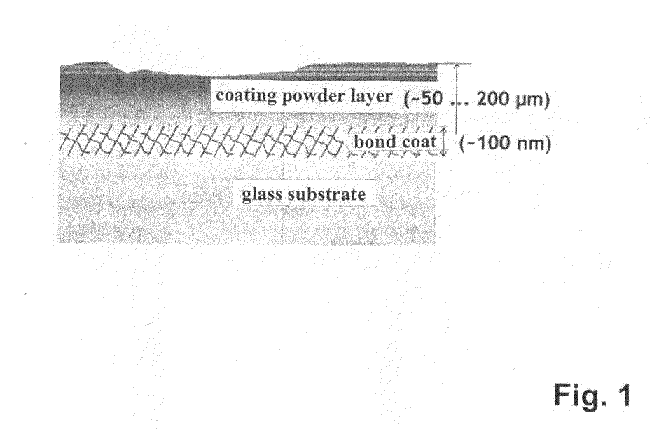

The result of this technology is a layer system consisting of a coating powder layer (CPS), an adhesion promoter and a glass substrate (FIG. 1).

The used CPS composition comprises:

| Component | Amount used | corresponds to |
|---|---|---|
| Coating powder | 118.5 g | 39.83% |
| Water | 172.8 g | 58.08% |
| Dispersing agent | 1.2 g | 0., 40% |
| Antifoaming agent | 1.5 g | 0.50% |
| Surface additive | 0.6 g | 0.20% |
| Rheology additive | 2.9 g | 0.97% |

In FIG. 1, it is seen that a bond coat constituted of the primer is approximately 100 nm thick and the printing (coating powder) layer is approximately 50-200 μm thick.

Wetting and dispersing additives can be for example:
solutions containing high-molecular block copolymers with pigment-affinity groups, i.e., groups that have an affinity for the pigment particles,
solutions containing copolymer with pigment-affinity groups,
solutions containing modified polyurethane, 100% non-ionic,
solutions containing acrylate polymer with neutralized anionic, carboxylate groups.
   Antifoaming agents can be for example:
mixtures containing foam destroying polysiloxanes and hydrophobic solids in polyglycol (silicon antifoaming agent),
mixtures containing foam destroying polymers other than polysiloxanes and hydrophobic solids, silicon-free,
mixtures containing foam destroying polymers and hydrophobic solids,
emulsion containing foam destroying polysiloxanes with hydrophobic solids.
   Rheology additives can be for example:
solutions containing modified urea and N-methylpyrrolidone,
solutions containing strongly Newtonian high shear thickeners,
solutions containing Newtonian high shear thickeners.
   Surface additives can be for example:
solutions containing polyether-modified polydimethylsiloxane.

1-9. (canceled)

10. A solvent-free mixture for coating or for serving as a printing ink, comprising a slurry of a coating powder in water, wherein the powder comprises pigment, is curable by polymerization and is sufficiently fine to pass through nozzles of an ink jet printer whereby the mixture is digitally printable.

11. Solvent-free printing ink, comprising the mixture of claim 10, wherein the powder comprises polyester epoxide.

12. Solvent-free printing ink of claim 11, wherein the powder has a particle size of 3 μm.

13. Solvent-free printing ink according to claim 11, further comprising one or more of the following additives or agents: dispersing additive; antifoaming agent; surface additive; and rheology additive.

14. Solvent-free printing ink according to claim 13, further comprising said dispersing additive and wherein said dispersing additive comprises a solution containing at least one of the following: high-molecular block polymer having pigment-affinity groups; modified polyurethane which is 100% non-ionic; and acrylate polymer having anionic, neutralized carboxylate groups.

15. Solvent-free printing ink according to claim 13, further comprising said antifoaming agent and wherein said antifoaming agent comprises a mixture containing a foam-destroying polysiloxane and a hydrophobic solid in a polyglycol or a mixture containing a foam-destroying polymer other than a polysiloxane and a hydrophobic solid or an emulsion of a foam-destroying polysiloxane and a hydrophobic solid.

16. Solvent-free printing ink according to claim 13, further comprising said rheology additive and wherein said rheology additive comprises a solution that contains a modified urea and a methylpyrrolidone or comprises a Newtonian high-shear thickener.

17. Solvent-free printing ink according to claim 13, further comprising said surface additive and wherein said surface additive comprises a solution containing a polyether-modified polydimethylsiloxane.

18. A method of applying a coating mixture or printing ink of any of claims 11-17 on a glass surface, comprising
cleaning the glass surface with a cleaner comprising acetic acid,
pretreating the glass surface by flame pyrolysis wherein siloxanes are introduced into the flame thereby to produce a SiOₓ layer on the glass surface,
air-brushing onto the SiOₓ layer an adhesion-promoting primer layer comprising a silane in propanol,
flushing the primer layer,
then, with said coating mixture or printing ink, coating or, by means of a digital ink jet, printing an image onto the thus pretreated and primed glass surface, and
thereafter curing the thus applied coating mixture or printing ink by means of infrared heating thereof.
